(19) United States
(12) Patent Application Publication
(10) Pub. No.: US 2012/0320096 A1
(43) Pub. Date: Dec. 20, 2012

(54) GAMMA CURVE VOLTAGE GENERATION

(76) Inventor: Jeffrey Small, Rochester, NY (US)

(21) Appl. No.: 13/164,116

(22) Filed: Jun. 20, 2011

(51) Int. Cl. G09G 5/10; G05F 3/02

(52) U.S. Cl. 345/690; 323/304

(57) ABSTRACT

A gamma curve voltage generator circuit comprises a first linear resistor string and a second linear resistor string. The first linear resistor string comprises resistors of a first resistor value and corresponds to a first portion of a gamma curve. A first end of the first linear resistor string is ohmically coupled to a first end of the second linear resistor string. The second linear resistor string comprises resistors of a second resistor value and corresponds to a second portion of the gamma curve. The first resistor value is different from the second resistor value.

### BACKGROUND

Liquid Crystal Display (LCD) devices and other display devices use a variety of techniques to generate voltages that correspond in some fashion to a gamma curve, which is a non-linear curve that maps pixel luminance values, such as pixel grey-level values, to drive voltage values.

### SUMMARY

A gamma curve voltage generator circuit comprises a first linear resistor string and a second linear resistor string. The first linear resistor string comprises resistors of a first resistor value and corresponds to a first portion of a gamma curve. A first end of the first linear resistor string is ohmically coupled to a first end of the second linear resistor string. The second linear resistor string comprises resistors of a second resistor value and corresponds to a second portion of the gamma curve. The first resistor value is different from the second resistor value.

### BRIEF DESCRIPTION OF DRAWINGS

The drawings referred to in this Brief Description of Drawings should not be understood as being drawn to scale unless specifically noted. The accompanying drawings, which are incorporated in and form a part of the Description of Embodiments, illustrate various embodiments of the present invention and, together with the Description of Embodiments, serve to explain principles discussed below, where like designations denote like elements, and:

FIG. 1 illustrates gamma curves for three different displays, according various embodiments;

FIG. 2A is a high level block diagram of an example display device, in accordance with various embodiments;

FIG. 2B is a more detailed block diagram of an example display device, in accordance with various embodiments;

FIG. 3 illustrates an example gamma curve voltage generator circuit, according to various embodiments; and

FIG. 4 shows a flow diagram of an example method of gamma curve voltage generation, in accordance with various embodiments.

### DESCRIPTION OF EMBODIMENTS

The following Description of Embodiments is merely provided by way of example and not of limitation. Furthermore, there is no intention to be bound by any expressed or implied theory presented in the preceding technical field, background, brief summary or the following detailed description.

### Overview of Discussion

Herein, various embodiments are described that display devices, display device drivers, and methods that facilitate improved, usability. Discussion begins with description of some example gamma curves for a variety different display panels (e.g., Liquid Crystal Display panels). An example display device, which includes a display such as an LCD panel is then described. The display device includes a gamma curve voltage generator circuit, which is then described in greater detail. The gamma curve voltage generator circuit is configured to generate gamma curve voltages for a variety of display panels. A particular gamma curve based on the adjustment values for the particular display panel. Operation of a gamma curve voltage generator circuit is described in further detail in conjunction with description of a method of gamma curve voltage generation.

### Example Gamma Curves for Display Devices

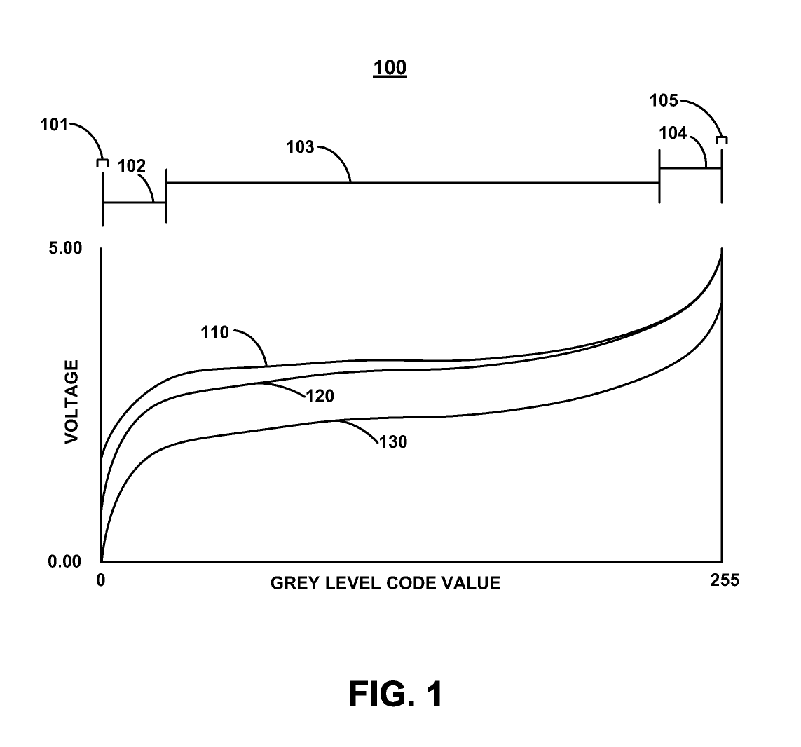

FIG. 1 illustrates gamma curves (110, 120, 130) for three different display panels, according various embodiments. Manufacturers typically supply gamma curves for use with their display panels. For example, in one embodiment: gamma curve 110 is a gamma curve for a display panel of manufacturer A; gamma curve 120 is for a gamma curve for a display panel of manufacturer B; and gamma curve 130 is a gamma curve for a display panel of manufacturer C. In one embodiment, a display panel of manufacturer A may have a red gamma curve, a green gamma curve and a blue gamma curve, where at least one may correspond to gamma curve 110. In another embodiment, a display panel of manufacturer B may have a red gamma curve, a green gamma curve and a blue gamma curve, where at least one may correspond to gamma curve 120. In a further embodiment, a display panel of manufacturer C may have a red gamma curve, a green gamma curve and a blue gamma curve, where at least one may correspond to gamma curve 130. In yet further embodiments, a display panel may have gamma curves corresponding to other colors. In other embodiments, a display panel may have more than three gamma curves, where each may correspond to a different color. In various embodiments, a display panel may have less than three gamma curves. The supplied gamma curves may be utilized to map input grey level values received by a display device to output drive voltage levels for the display panel that is employed in the display device.

In the embodiment illustrated in FIG. 1, even though gamma curves 110, 120, and 130 differ from one another, they have some common features related to their sigmoidial shape. All start at a lowest and fixed voltage at starting point 101 (starting voltages may differ from gamma curve to gamma curve). In initial region 102, each of the gamma curves experiences a rapid steeply sloped, and non-linear increase. In middle region 103, each of the gamma curves has a broad, gradually sloped response which encompasses the majority of the grey level code values and in which change is fairly linear. In end region 104, each of the gamma curves again has a steeply sloped, non-linear increase in voltage. The slope of end region 104 may be different than the slope of initial region 102 in some gamma curves. At ending point 105, each of the gamma curves ends at a highest and fixed voltage (ending voltages may differ from gamma curve to gamma curve). In other embodiments, gamma curves having other shapes are also possible. For example, the slope of region 102 may be more or less than the slope of region 103. Further, the slope of region 103 may be more or less than the slope of region 104.

### Example Display Device

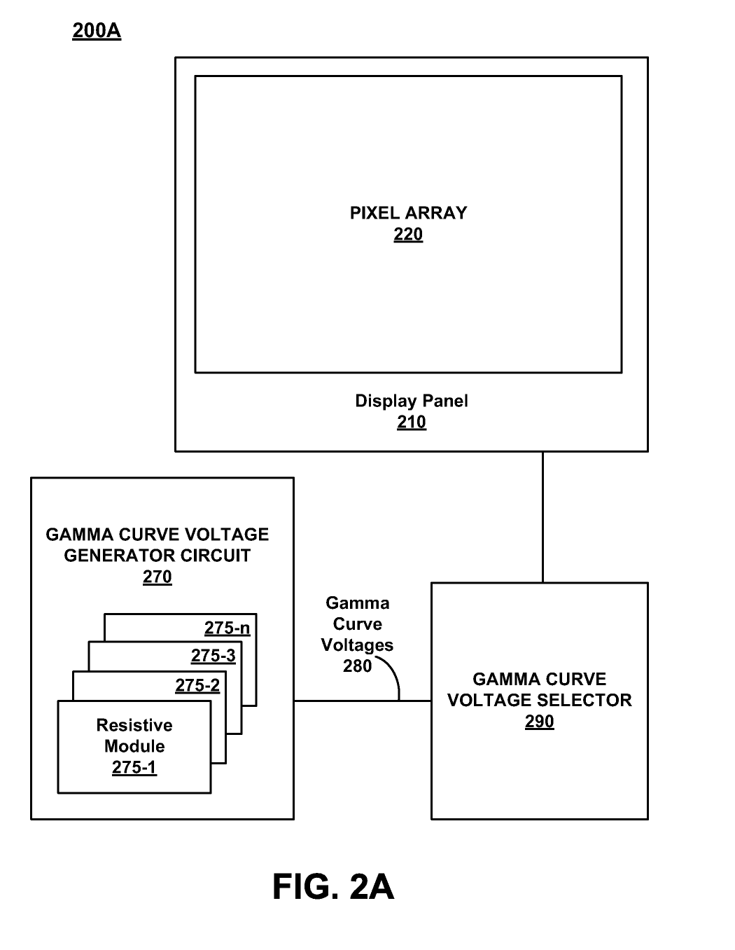

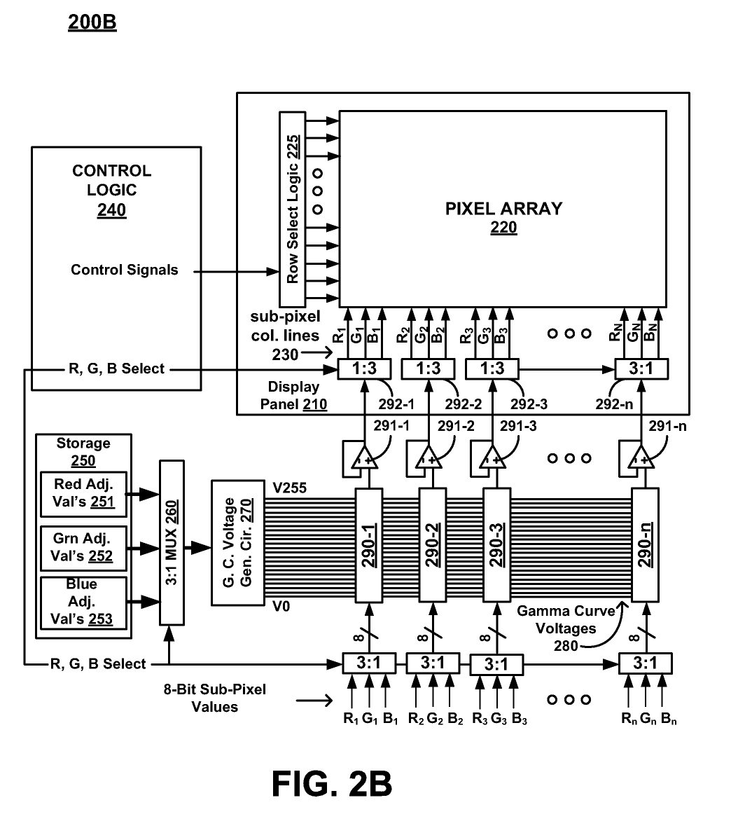

FIG. 2A is a high level block diagram of an example display device 200A, in accordance with various embodiments. For purposes of example, and not of limitation, display device 200A is illustrated as containing gamma curve voltage generator circuit 270. In various embodiments, gamma curve voltage generator circuit 270 may comprise firmware and/or software in combination with circuitry. In one embodiment, gamma curve voltage generator circuit 270 comprises a plurality of resistive modules 275-1, resistive module 275-2, . . . 275-n. A first resistive module 2751-1 is configured to generate a first plurality of gamma curve voltages in accordance with a first portion of a gamma curve, such as gamma curve 110. Resistive module 275-2 is configured to generate a second plurality of gamma curve voltages in accordance with a second portion of a gamma curve, such as gamma curve 110. In one embodiment, when a third resistive module is included it is configured to generate a third plurality of gamma curve voltages in accordance with a third portion of a gamma curve, such as gamma curve 110. In various embodiments, each resistive module 275 may comprise a linear resistor string, n such embodiments resistive module 275 may be referred to as a linear resistor string or resistor string. In the following description, a first resistive module comprising a linear resistor string may be referred to as a first linear resistor string; a second resistive module comprising a linear resistor string may be referred to as a second linear resistor string; and a third resistive module comprising a linear resistor string may be referred to as a third linear resistor string. In other embodiments, each resistive module 275 may comprise a printed resistor with multiple tap points along its length, or other resistive device which can generate a plurality of resistances at a plurality of tap points. Further, while in some embodiments first, second and third resistive modules are described, in other embodiments, a gamma curve voltage generator circuit may comprise more or less than three resistive modules.

In one embodiment, the gamma curve for which gamma curve voltages are generated may be selected from a set of gamma curves, for example gamma curve 110 may be selected from a plurality of gamma curves for a single display panel 210 (e.g., a red gamma curve for display panel 210, a blue gamma curve for display panel 210, a green gamma curve for display panel 210, etc.) and/or from a plurality of gamma curves for different displays (e.g., a red gamma curve for a display made by manufacturer A, a red gamma curve for a display made by manufacturer B, and a red gamma curve for a display made by manufacturer C, etc.). The selection may be based on the desired sub-pixel display color and/or the manufacturer. In other embodiments, a single gamma curve may be used. In further embodiments, the gamma curve may be hardwired within the circuitry and/or firmware of display device 200A.

Gamma curve voltage selector 290 is configured to select first gamma curve voltage from a set of gamma curve voltages 280 that comprise the first plurality of gamma curve voltages, the second plurality of gamma curve voltages, and additional pluralities of gamma curve voltages when more than two resistive modules 275 are utilized. Gamma curve voltage selector 290 is further configured to couple the first gamma curve voltage with a respective pixel of pixel array 220 in display panel 210. The first and second pluralities of gamma curve voltages correspond to first and second subsets of a set of grey-level values. In one embodiment, the set of grey-level values may comprise 256 values. In other embodiments, different amounts of values may be used. In various embodiments, the grey-level values may be based on a grey-level code. For example, the 256 grey-level values may be based on an 8-bit grey-level code values. In other embodiments, other numbers of code values may be used.

In one embodiment, gamma curve voltage generator circuit 270, and corresponding resistive modules 275 generate a different set of reference gamma curve voltages for each different gamma curve. In one embodiment, each sub-pixel color may have a corresponding gamma curve; for example, in one embodiment, a red gamma curve corresponding to red sub-pixels, a green gamma curve corresponding to green sub-pixels, and a blue gamma curve corresponding to blue sub-pixels. In another embodiment, a red gamma curve corresponding to red sub-pixels, a green gamma curve corresponding to green sub-pixels, a blue gamma curve corresponding to blue sub-pixels and a white gamma curve corresponding to white sub-pixels. In other embodiments, different display device manufacturers may have corresponding gamma curves. In yet further embodiments, each display device manufacture may have a gamma curve corresponding to each sub-pixel color. The gamma curves may be stored within a storage device, and may be selected based on the display device manufacturer and/or sub-pixel color to be displayed. In one embodiment, gamma curve voltage generator circuit 270 selects the gamma curve. In other embodiments, the gamma curve is selected externally from gamma curve voltage generator circuit 270 and communicated to gamma curve voltage generator circuit 270. External selection can take place at various times and locations. For example, in one embodiment external selection of a gamma curve occurs as a part of manufacture of a display device 200. In another embodiment, gamma curve selection can occur just prior to generating gamma curve voltages during operation of display device 200A.

In various embodiments, gamma curve voltage selector 290 is configured to select a gamma curve voltage 280 corresponding to the sub-pixel color to be displayed by display device 200A. In one example embodiment, where there are 256 grey-level values, a gamma curve voltage selector 290 connects exactly one of these voltages to an associated pixel, according to the 8-bit value for that pixel's red, green or blue sub-pixel. Note that a given gamma curve voltage 280 output from gamma curve voltage generator circuit 270 may be connected to none of the pixels or to any number of the pixels. This depends on the sub-pixel data

FIG. 2B is a more detailed block diagram of an example display device 200B, in accordance with various embodiments. For purposes of example, and not of limitation, display device 200B is illustrated as utilizing a thin film transistor liquid crystal display panel comprising red, green and blue subpixels. Display panel 210 includes one or more of pixel array 220, row select logic 225, and sub-pixel column lines 230. Control logic 240 asserts one of the R, G or B (red, green, or blue) select signals, thereby selecting either the red sub-pixels, or the green sub-pixels, or the blue sub-pixels of pixel array 220 in display panel 210. At the proper time, control logic 240 also asserts one of the R, G or B select signals, corresponding to the red, green or blue sub-pixels of pixel array 220. Control logic 240 also provides control signals to row select logic 225 (on display panel 210) so that one row of pixel array 220 is selected. An entire row of red, green and blue sub-pixel values, corresponding to the selected row of pixel array 220, is applied to the 3:1 selectors shown at the bottom of FIG. 2B. In some embodiments, control logic 240 selects R, G, or B (red, green, or blue) pixel values and corresponding red adjustment values 251, green adjustment values 252, or blue adjustment values 253.

In FIG. 2B, gamma curve voltage generator circuit 270 is used to generate a set of 256 analog reference gamma curve voltages 280, where each voltage corresponds to one of the 256 possible adjustment values (e.g., red adjustment values 251, green adjustment values 252, or blue adjustment values 253, or the like). The 256 possible adjustment values are based on 8-bit grey level code values that are used as non-limiting examples herein. Because this correspondence is different for red, green and blue, gamma curve voltage generator circuit 270 generates a different set of reference gamma curve voltages for each color. Gamma curve voltage generator circuit 270 is controlled by a stored set of adjustment values (251, 252, 253) which provide voltage adjustment settings and tap settings that configure gamma curve voltage generator circuit 270 to output voltages that replicate a selected gamma curve associated with display panel 210 (i.e., a particular red, blue, or green gamma curve for display panel 210). It is appreciated that such adjustment values for a particular display panel 210 may be stored in a solid state storage 250. Additionally, storage 250 may store such adjustment values for a plurality of different display panels 210, which may include display panels of a plurality of different manufactures. When adjustment values for a plurality of different display panels are stored in storage 250, the adjustment values for the display panel 210 that is being utilized in display device 200 are selected. One of the selected red 251, green 252 or blue 253 sets of adjustments values is connected through a 3:1 multiplexer 260 to the digital inputs of gamma curve voltage generator circuit 270.

In one embodiment, for a given pixel, the associated 256:1 gamma curve voltage selector 290 (290-1, 290-2, 290-3, . . . 290-n) connects exactly one of these voltages to an associated buffer amplifier 291, according to the 8-bit value for that pixel's red, green or blue sub-pixel. Note that a given reference gamma curve voltage, of gamma curve voltages 280, that is output from gamma curve voltage generator circuit 270 may be connected to none of the buffer amplifiers 291 or to any number of the buffer amplifiers 291. This depends on the sub-pixel data. In one embodiment, each gamma curve voltage selector 290 couples the selected, voltage from gamma curve voltages 280 to a buffer amplifier 291 (291-1, 291-2, 291-3, . . . 291-n) and the buffer amplifier 291 drives a buffered replica of this selected gamma curve voltage onto the corresponding pixel. In embodiments where there are three sub-pixel colors, the gamma curve voltage is connected through a 1:3 selector 292 (292-1, 292-2, 292-3, . . . 292-n) to the appropriate red, green or blue sub-pixel column via sub-pixel column lines. In other embodiments, the size of a selector 292 corresponds to the available colors of the sub-pixels. In embodiments where there are more sub-pixel colors, a selector 292 may be larger and in embodiments where there are less sub-pixel colors, a selector 292 may be smaller. The sub-pixel (in the row currently-selected by row select logic 225) and the parasitic capacitance of the sub-pixel column are charged to this voltage. In various embodiments, this process occurs for each color of the sub-pixels. In one embodiment, gamma curve voltage selector 290 comprises a voltage selector corresponding to each column line of display device 200A. In other embodiments, each gamma curve voltage selector 290 corresponds to more than one column of the display device.

In the embodiment depicted in FIG. 2B, and in various embodiments, gamma curve voltage generator circuit 270 changes its output gamma curve voltages 280 per selected sub-pixel color. For example, once when the red sub-pixels columns are selected, again for the green sub-pixel column, and finally for the blue sub-pixel columns. In other embodiments, gamma curve voltage generator circuit 270 produces the same gamma curve voltages for more than one sub-pixel color. Although times may vary per display panel, a typical line time for an 864 row×480 column 60 fps display is often no longer than 1/(864×60)=19 μs. In various embodiments, less than a third of this time is available for each color group of sub-pixels.

### Example Gamma Curve Voltage Generator Circuit

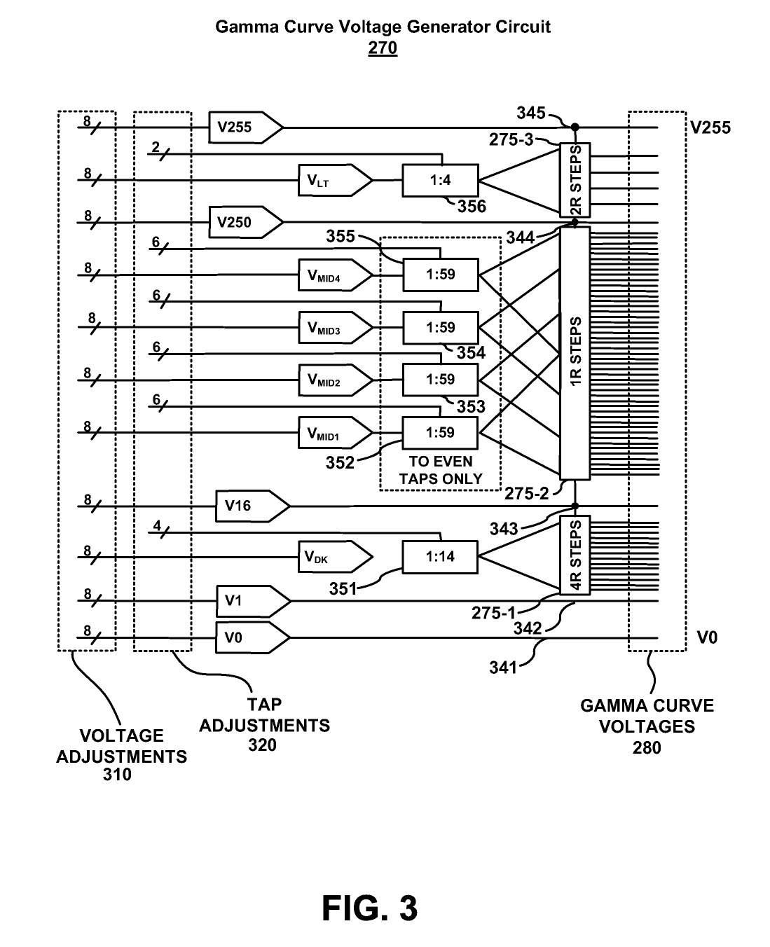

FIG. 3 illustrates an example gamma curve voltage generator circuit 270, according to various embodiments. In discussion of FIG. 3, reference is made to components of FIGS. 2A and 2B. In some embodiments, gamma curve voltage generator circuit 270 is coupled with or disposed within a display driver ASIC (Application Specific Integrated Circuit) of a display device 200 (e.g., 200A, 200B, or the like). In gamma curve voltage generator circuit 270, adjustment values from 3:1 multiplexer 260 in FIG. 2B are applied to voltage adjustment inputs 310 (referred to herein as “voltage adjustments”) and tap point adjustment inputs 320 (referred to herein as “tap adjustments”). As a result, the resistive modules 275 (275-1, 275-2, etc.), which may each comprise individual linear resistor strings, create a piecewise-linear replication of gamma curve voltages for display panel 210. An output voltage from gamma curve voltages 280 may be selected, by gamma curve voltage selector 290 that is included in a display device 200. In one embodiment, gamma curve voltage selector 290 comprises one or more of voltage selectors 290-1, 290-2, 290-3, . . . 290-n.

As is illustrated by the gamma curves of FIG. 1, even though some commonality exists in the general shape of gamma curves 110, 120, and 130, the local slopes of these curves can vary significantly one from another. Because of this, a gamma curve voltage generation method of “pulling” the voltages of fixed tap points up or down can only give a good match to the required mapping for a given display panel if the distances between adjacent fixed tap points do not span large changes in slope. Otherwise, a significant amount of ripple is induced in the error between the desired gamma curve and the obtained gamma curve. This ripple causes annoying visible artifacts (contouring) in smooth (low gradient) areas of displayed images, especially in the intermediate grey-level regions of such images.

With reference again to FIG. 3, to overcome this difficulty, gamma curve voltage generation circuit 270 adds the ability to adjust both the positions of the adjustable tap points (351, 352, 353, 354, 355, 356) on the output resistors (resistive modules 275-1, 275-2, 275-3) as well as the values of voltages (generated by voltage sources V0, V1, Vdk, V16, Vmid1, Vmid2, Vmid3, Vmid4, V250, Vlt, V255) that are applied to these tap points. However, as shown in the bottom half of FIG. 3, not all tap points always require this flexibility of adjustable tap point. Thus, in some embodiments, some tap points may remain fixed, while others may be moveable. In particular, in the illustrated embodiment, tap points 341, 342, 343, 344, and 345 which are respectively associated with voltages supplied by voltage sources V0, V1, V16, V250, and V255 are fixed; while tap points 351 associated with voltage supplied by voltage source Vdk, tap points 352 associated with supplied by voltage source Vmid1, tap points 353 associated with voltage supplied by voltage source Vmid2, tap points 354 associated with voltage supplied by voltage source Vmid3, tap points 355 associated with voltage supplied by voltage source Vmid4, and tap points 356 associated with voltage supplied by voltage source Vlt are selectively adjustable via tap adjustments 320. As is illustrated with respect to resistive module 275-2, in some embodiments multiple adjustable voltages (supplied by voltage sources Vmid1, Vmid3, Vmid4, etc) each with a respective plurality of adjustable tap points (352, 353, 354, 355) may be coupled with a resistive module; and some of the selectable tap points associated with one voltage may overlap with those of one or more other voltages that are associated with a resistive module. Although techniques described herein with respect to gamma curve voltage generator circuit 270 allow for both voltages and tap points to be adjusted, it should be appreciated that, in some embodiments, only one or the other may need to be adjusted with respect to one or more of resistive modules 275-1, 275-2 and 275-3 in order to achieve a desired gamma curve.

Tap adjustments 320 may be utilized to program a selected tap point at the input of a resistive module, at the output of a resistive module, or at some combination of both the input and output. Programmable tap points located on the output of, for example, a resistive module map a specific voltage generated from the resistive module to a corresponding grey level code value (i.e., position on the gamma curve).

In some embodiments, the tap point associated with one or more voltages supplied by voltage sources V0, V1, V16, V250, and V255 may also be programmable. In gamma curve voltage generator circuit 270, the driven tap points of one or more resistive modules may be varied both in voltage and position in order to generate a desired gamma curve. Further, due to the combination of programmable voltages and programmable tap points, matching to multiple gamma curves is possible with reduced amount of ripple in the error between the obtained gamma curve and the desired gamma curve (as compared to an approach with adjustable voltages and only fixed tap points). In a display panel 210 the reduction in ripple reduces contouring in smooth image regions of images displayed on the display panel.

With reference to FIG. 3 and to circuit 270, in the illustrated embodiment, resistive module 275-1 comprises a series-connected set of resistors of a first value of resistance; resistive module 275-2 comprises a series-connected set of resistors of a second value of resistance; and resistive module 275-3 comprises a series-connected set of resistors of a third value of resistance. A voltage tap point 342 is ohmically coupled to a first of two ends of resistive module 275-1. The second end of resistive module 275-1 is ohmically coupled to one of the two ends of resistive module 275-2 and to a second voltage tap point 343. The second of the two ends of resistive module 275-2 is ohmically coupled to a first of two ends of resistive module 275-3 (when included) and to voltage tap point 344. The second end of resistive module 275-3 (when included) is ohmically coupled with tap point 345.

The resistors of a first value in resistive module 275-1 and the resistors of a second value in resistive module 275-2 have differing resistance values from one another. For example, in sonic embodiments the resistors of a second value each have a resistance value of 1R (where R is a fixed positive value in ohms) and the resistors of a first value each have a greater resistance than 1R. For example, in some embodiments, the resistors of a first value may each have a resistance value that is a multiple of 1R, such as 2R, 3R, 4R (as illustrated), or the like. The resistors of a second value and the resistors of a third value (resistive module 275-3) may also have differing resistance values from one another. For example, in some embodiments when the resistors of a second value each have a resistance value of 1R, the resistors of a third value may each have a resistance value that is a multiple of 1R, such as 2R (as illustrated), 3R, 4R, or the like. Whole or fractional number multiples are possible. In various embodiments, depending upon the nature of the gamma curve being replicated, the resistors of a third value may be of the same or different resistance value than the resistors of a first value. In general, larger resistance values are used where (1) the gamma curve being produced is steep such that there is a large voltage change across each resistor and (2) where the total resistance from the output nodes to the nearest two driven taps (i.e., the Thévenin equivalent) is desired to remain at an acceptably low value. By using larger resistors where the voltage per resistor is high, power dissipation is minimized, as will be describe further herein.

With respect to the illustrated resistive modules 275-1, 275-2, and 275-3, the respective 4R, 1R and 2R per step sections, create a piecewise-linear gamma curve from which voltages may be selected when circuit 270 is active. For example, with reference to FIG. 1: the 4R resistor values of resistive module 275-1 correspond to the very steep sloped initial region 102 of the illustrated gamma curves; the 1R resistor values of resistive module 275-2 correspond the gently sloped middle region 103 of the illustrated gamma curves; and 2R resistor values of resistive module 275-3 correspond to the fairly steeply sloped end region of the illustrated gamma curves. By using larger resistors for the 2R and 4R values, power dissipation is reduced. In the example embodiment illustrated in FIG. 3, the complete gamma curve is composed of linear segments between V0-V1, V1-Vdk, Vdk-V16, V16-Vmid1, Vmid1-Vmid2, Vmid2-Vmid3, Vmid3-Vmid4, Vmid4-V250, V250-Vlt, and Vlt-V255.

Most LCD gamma curves have a large voltage difference between V0 and V1. This is illustrated in the vicinity of staring point 101 in example gamma curves 110, 120, and 130 of FIG. 1. As such, in gamma curve voltage generator circuit 270, voltages associated with V0 and V1 are directly driven. If voltages associated with V0 and V1 were derived from a resistor string instead of being directly driven, this large voltage difference would be connected across a single resistor, which may result in large power dissipation. Because the two voltages associated with V0 and V1 (i.e., in the vicinity of starting point 101 in FIG. 1) are far apart, any offset voltage errors from the voltage sources are negligible compared to V0 and V1.

For similar reasons, resistive modules 275-1, 275-2, and/or 275-3 are used. As described above, within a given resistive module, the individual resistor elements (such as individual resistors in a resistor string) all have the same value, but this value is may be different for each of the resistive modules. In one embodiment, resistive module 275-1, between V1 and V16, have large resistance values because desired gamma curves are steep in this region. Thus, the voltage across each resistor is relatively large. By using larger resistor sizes (4× those in the center of the gamma curve in this example), the power dissipation is reduced. In the middle of the gamma curve, located between V16 and V250, is resistive module 275-2. The voltage across each resistor in resistive module 275-2 is smaller than that of resistive module 275-1, thus resistors of small resistance value may be used without drastically increasing the power dissipation. It is desirable to use smaller resistors in this portion of the gamma curve because the driven taps are, in general, further apart. By using smaller resistor values, the Thévenin resistance of each output voltage node is reduced. In one embodiment, the resistance values of the individual resistors in resistive module 275-3, between V250 and V255, are somewhat larger than those of resistive module 275-2 because the gamma curve is somewhat steep, but not as steep as between V1 and V16.

Because both the tap voltages and tap points of the driven taps within each resistor string are adjustable by the improved method of this invention, it is possible to get very good matching between the resulting piecewise-linear curve and a desired smooth gamma curve.

Utilizing the techniques described herein with respect to gamma curve voltage generator circuit 270, good matching between a desired and generated gamma curve can be obtained even if the programmable tap points are optionally limited to just odd numbered taps or even-numbered taps (as depicted in FIG. 3) in the central portion 103 of the gamma curve. This reduces the number of analog transmission gates that are required. In the example shown in FIG. 3, a total of 4+59+59+59+59+14=254 transmission gates are required. This can be up to a four times reduction compared to the conventional circuits which can be used to implement multiple gamma curves.

### Example of Power Savings

The following is a calculation of the power that would be dissipated in a resistor string for an actual gamma curve in a display driver using the new techniques described herein and when not using these techniques (i.e., in a conventional manner). The power savings calculations are based upon a gamma curve produces by driving programmable voltage sources at tap points 0, 1, 6, 8, 16, 38, 108, 180, 226, 250, 254 and 255. As in FIG. 3, a resistive module with 4R steps is utilized between taps 1 and 16, a resistive module with 1R steps is utilized between taps 16 and 250 and a resistive module with 2R steps is utilized between taps 250 and 255.

Using the new techniques described herein, with R=220 ohms, the resistance per step between taps 1 and 16 is 880 Ohms (4R), between taps 16 and 250 the resistance per step is 220 ohms (1R), and between taps 250 and 255 the resistance per step is 440 ohms (2R). Tap 0 is driven directly and is not connected to the resistive modules. This results in a calculated power of 437 microwatts.

When not using the new techniques described herein, and resistance values are equal to 220 ohms, the power increases to 1184 microwatts.

To adequately drive the required load, the maximum Thévenin output impedance must be kept small. In both cases, the maximum Thévenin output impedance of any tap occurring in the middle of the “1R” resistive module 275-2 is 3960 ohms (which is satisfactory). However, utilizing the new techniques described herein reduces the power dissipation by a factor of 2.7 (1184/437=2.7).

In order to reduce the power without the new techniques described herein, the value of R must be increased, but this also increases the maximum Thévenin output impedance by a factor of 2.7 to a value of (1184/437)×3960=10,729 ohms (which is not desirable or satisfactory). Thus, the new techniques described herein allow the power to be greatly reduced without increasing the maximum Thévenin output impedance of a gamma curve voltage generator circuit.

### Example Method of Gamma Curve Voltage Generation

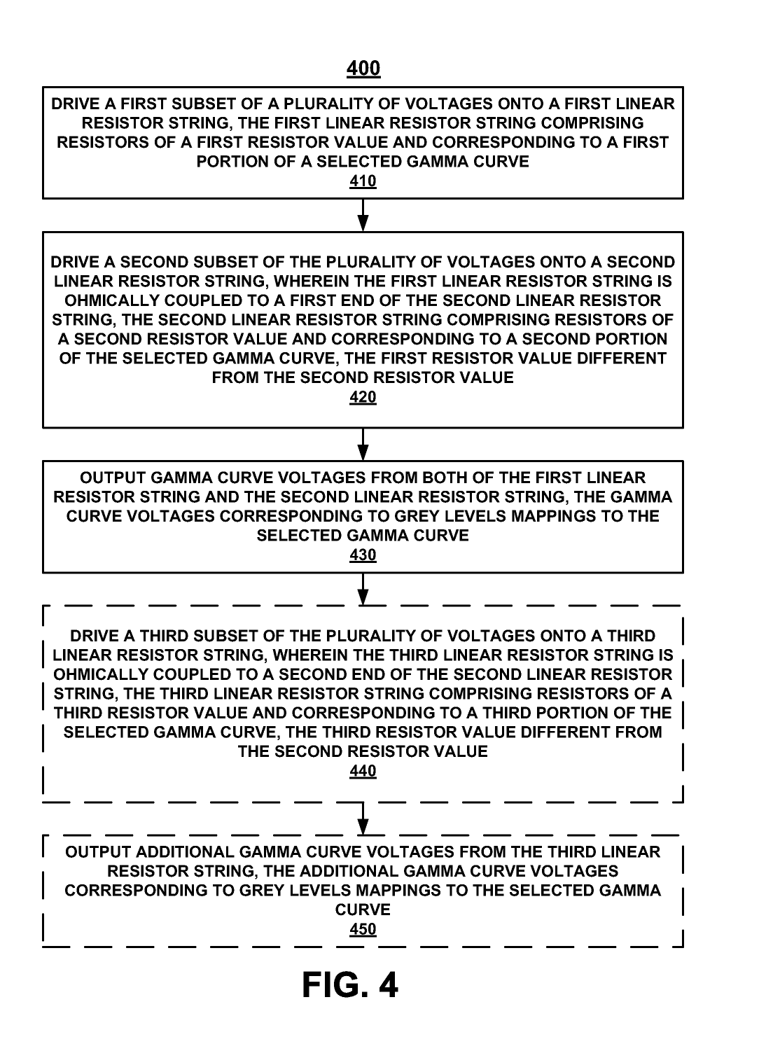

FIG. 4 illustrates a flow diagram of an example method of gamma curve voltage generation, in accordance with various embodiments. For purposes of illustration, during the description of flow diagram 400, reference will be made to features illustrated in one or more of FIGS. 1-3. In some embodiments, not all of the procedures described in flow diagram 400 are implemented. In some embodiments, other procedures in addition to those described may be implemented. In some embodiments, procedures described flow diagram 400 may be implemented in a different order than illustrated and/or described.

At 410 of flow diagram 400, in one embodiment, a first subset of a plurality of voltages is driven onto a first linear resistor string. In one embodiment, the first linear resistor string comprises resistors of a first resistor value and corresponds to a first portion of a selected gamma curve. With reference to FIGS. 2A, 2B and 3, this can comprise driving voltages supplied by voltage sources V1, Vdk and V16 onto a resistor string that is comprised by resistive module 275-1 in order to generate the bottom portion of a selected gamma curve associated with a set of adjustment values (e.g., 251, 252, or 253) that are supplied to gamma curve voltage generator circuit 270.

At 420 of flow diagram 400, in one embodiment, a second subset of a plurality of voltages is driven onto a second linear resistor string. The first linear resistor string is ohmically coupled to a first end of the second linear resistor string. The second linear resistor string comprises resistors of a second resistor value which correspond to a second portion of a selected gamma curve, and the first resistor value is different from the second resistor value. With reference to FIG. 3, this can comprise driving voltage(s) supplied by one or more of voltage sources V16, Vmid1, Vmid2, Vmid3, Vmid4 and V250 onto a resistor string that includes resistive module 275-2. In one embodiment the first linear resistor string and the second linear resistor string are configured such that voltage dropped across each resistor of the first linear resistor string is greater than voltage dropped across each resistor of the second linear resistor string. This may take place when the resistors of resistive module 275-1 are of larger resistance value than those of resistive module 275-2.

At 430 of flow diagram 400, in one embodiment, gamma curve voltages are output from both of the first linear resistor string and the second linear resistor string. The gamma curve voltages correspond to grey level code value mappings of the selected gamma curve which has been generated. For example, gamma curve voltages 280 that are output from resistive modules 275-1 and 275-2 correspond to grey level code value mappings of the bottom and middle portions of the selected gamma curve which has been generated.

At 440 of flow diagram 400, in one embodiment, a third subset of the plurality of voltages is driven onto a third linear resistor string. The third linear resistor string is ohmically coupled to a second end of the second linear resistor string, and the third linear resistor string comprises resistors of a third resistor value that correspond to a third portion of the selected gamma curve. The third resistor value is different from the second resistor value. With reference to FIG. 3, this can comprise driving voltage supplied by voltage sources V250, Vlt and V255 onto a resistor string that is comprised by resistive module 275-3.

At 450 of flow diagram 400, in one embodiment, additional gamma curve voltages are output from the third linear resistor string. The additional gamma curve voltages correspond to grey levels mappings to the selected gamma curve. For example, gamma curve voltages 280 that are output from resistive module 275-3 correspond to grey level code value mappings of the upper portion of the selected gamma curve which has been generated.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. A gamma curve voltage generator circuit, said circuit comprising:
a first linear resistor string comprising resistors of a first resistor value and corresponding to a first portion of a gamma curve; and
a second linear resistor string, wherein a first end of said first linear resistor string is ohmically coupled to a first end of said second linear resistor string, said second linear resistor string comprising resistors of a second resistor value and corresponding to a second portion of said gamma curve, said first resistor value different from said second resistor value.

2. The circuit of claim 1, further comprising:
a first voltage tap point ohmically coupled to a second end of said first linear resistor string; and
a second voltage tap point ohmically coupled to said first end of said first linear resistor string and said first end of said second linear resistor string.

3. The circuit of claim 2, wherein at least one of said first voltage tap point and said second voltage tap point is programmable.

4. The circuit of claim 2, wherein at least one said first voltage tap point and said second voltage tap point is fixed.

5. The circuit of claim 1, further comprising:
a first plurality of programmable tap points corresponding to various positions within said first linear resistor string; and
a second plurality of programmable tap points corresponding to various positions within said second linear resistor string.

6. The circuit of claim 5, further comprising:
a third linear resistor string with a first end thereof ohmically coupled to a second end of said second linear resistor string, said third linear resistor string comprising resistors of a third resistor value and corresponding to a third portion of said gamma curve, said third resistor value different than said second resistor value.

7. The circuit of claim 6, further comprising:
a third voltage tap point ohmically coupled to a second end of said third linear resistor string; and
a fourth voltage tap point ohmically coupled to said first end of said third linear resistor string and said second end of said second linear resistor string.

8. The circuit of claim 6, wherein said third resistor value is larger than said second resistor value.

9. The circuit of claim 1, wherein said first resistor value is larger than said second resistor value.

10. A display device, said display device comprising
a gamma curve voltage generator circuit comprising:
a first resistive module configured for generating a first plurality of gamma curve voltages in accordance with a first portion of a selected gamma curve, wherein said first plurality of gamma curve voltages corresponds to a first subset of a set of grey-level values; and
a second resistive module configured for generating a second plurality of gamma curve voltages in accordance with a second portion of said selected gamma curve, wherein said second plurality of gamma curve voltages corresponds to a second subset of said set of grey-level values, wherein a first end of said first resistive module is ohmically coupled to a first end of said second resistive module, and wherein said first resistive module includes a plurality of resistors of a first resistor value and said second resistive module includes a plurality of resistors of a second resistor value, said first resistor value different from said second resistor value;
a gamma curve voltage selector configured to select a first gamma curve voltage from a set of voltages comprising said first plurality of gamma curve voltages and said second plurality of gamma curve voltages; and
a pixel array, wherein said gamma curve voltage selector is further configured to couple said first gamma curve voltage with a respective pixel of said pixel array.

11. The display device of claim 10, further comprising:
a first plurality of programmable tap points corresponding to various positions within said first resistive module; and
a second plurality of programmable tap points corresponding to various positions within said second resistive module string.

12. The display device of claim 10, further comprising;
a first voltage tap point ohmically coupled to a second end of said first resistive module; and
a second voltage tap point ohmically coupled to said first end of said first resistive module and said first end of said second resistive module.

13. The circuit of claim 12, wherein at least one of said first voltage tap point and said second voltage tap point is programmable.

14. The circuit of claim 12, wherein at least one said first voltage tap point and said second voltage tap point is fixed.

15. The display device of claim 12, further comprising:
a third resistive module configured for generating a third plurality of gamma curve voltages in accordance with a third portion of said selected gamma curve, wherein said third plurality of voltages corresponds to a third subset of said set of grey-level values, wherein a first end of said third resistive module is ohmically coupled to a second end of said second resistive module, and wherein said third resistive module includes a plurality of resistors of a third resistor value, said third resistor value different than said second resistor value.

16. The display device of claim 15, wherein said third resistor value is larger than said second resistor value.

17. The display device of claim 10, wherein said first resistor value is larger than said second resistor value.

18. A method of gamma curve voltage generation, said method comprising:
driving a first subset of a plurality of voltages onto a first linear resistor string, said first linear resistor string comprising resistors of a first resistor value and corresponding to a first portion of a selected gamma curve; and
driving a second subset of said plurality of voltages onto a second linear resistor string, wherein said first linear resistor string is ohmically coupled to a first end of said second linear resistor string, said second linear resistor string comprising resistors of a second resistor value and corresponding to a second portion of said selected gamma curve, said first resistor value different from said second resistor value; and
outputting gamma curve voltages from both of said first linear resistor string and said second linear resistor string, said gamma curve voltages corresponding to grey levels mappings to said selected gamma curve.

19. The method as recited in claim 18, further comprising:
driving a third subset of said plurality of voltages onto a third linear resistor string, wherein said third linear resistor string is ohmically coupled to a second end of said second linear resistor string, said third linear resistor string comprising resistors of a third resistor value and corresponding to a third portion of said selected gamma curve, said third resistor value different from said second resistor value; and
outputting additional gamma curve voltages from said third linear resistor string, said additional gamma curve voltages corresponding to grey levels mappings to said selected gamma curve.

20. The method as recited in claim 18, wherein said first linear resistor string and said second linear resistor string are configured such that voltage dropped across each resistor of said first linear resistor string is greater than voltage dropped across each resistor of said second linear resistor string.
